(19) United States
(12) Patent Application Publication
(10) Pub. No.: US 2004/0009388 A1
(43) Pub. Date: Jan. 15, 2004

(54) Electrocatalyst-containing layer

(76) Inventor: Peter Faguy, Rochester Hills, MI (US)

Correspondence Address: ALFRED H. MURATORI, MICROCOATING TECHNOLOGIES, INC., 5315 PEACHTREE INDUSTRIAL BLVD, ATLANTA, GA, 30341-2107, US

(21) Appl. No.: 10/421,092

(22) Filed: Apr. 23, 2003

Related U.S. Application Data
(60) Provisional application No. 60/375,226, filed on Apr. 24, 2002.

(51) Int. Cl. H01M 4/96; H01M 4/92

(52) U.S. Cl. 429/42; 429/44

(57) ABSTRACT

An electrocatalyst layer, particularly an electrocatalyst layer used in a direct methanol fuel cell, is enhanced in catalytic efficiency by inclusion of particulates of a refractory oxide, such as silica.

### PREVIOUS APPLICATION

This application claims priority to U.S. Provisional patent Application No. 60/375,226, filed Apr. 24, 2002, hereby incorporated by reference in its entirety.

### FIELD OF THE INVENTION

The present invention is directed to electrocatalyst layers (ECLs), and more particularly to more efficient anode ECLs for direct methanol fuel cells (DMFCs).

### BACKGROUND OF THE INVENTION

Fuel cells, including proton exchange membrane fuel cells (PEMFCs) and direct methanol fuel cells (DMFCs), have been proposed as energy sources for a variety of needs, including providing the energy for powering automotive vehicles, consumer electronics, cell phone and laptops.

A drawback to more widespread use of fuel cells is their relatively high cost. Contributing to the relatively high cost of fuel cells is their use of expensive catalytic materials, such as platinum, ruthenium, and other costly noble or rare metals. More efficient utilization of such catalytic materials can reduce the cost of fuel cells.

### SUMMARY OF THE INVENTION

Electrocatalyst-containing layers, both anode and cathode ECLs for DMFCs, and particularly such ECLs employing platinum, in whole or in part, as the electrocatalyst, are improved in efficiency by incorporating, in particulate form, a refractory oxide, such as silica, ceria, zirconia or titania. The electrocatalyst and the refractory oxide form porous nanocomposite with ionomer.

### BRIEF DESCRIPTION OF THE DRAWINGS

FIG. 1 is a diagrammatic illustration of a fuel cell, which could be either a PEM fuel cell or a DMFC.

FIG. 2 is a diagrammatic illustration of apparatus useful for depositing ECLs in accordance with the present invention.

FIG. 3 is a graph comparing performance of a DMFC anode using ECLs with and without silica.

### DETAILED DESCRIPTION OF CERTAIN PREFERRED EMBODIMENTS

Electrocatalyst layers in accordance with the invention comprise a porous composite of the following: a solid state ionomeric material, an electrocatalyst in particulate form, a refractory oxide in particulate form in amounts sufficient to enhance the catalytic efficiency of the electrocatalyst, and/or an electrochemically stable electron conducting material. The porosity of the DMFC anode ECL must be sufficient to provide for movement of methanol to the electrocatalytic sites and movement of reaction products and water away from the active sites and to provide for the maximum number of active sites per unit volume. The ionomer should be a proton conducting polymer, and a preferred ionomeric material is persulfonated polytetrafluoroethylene, such as that sold under the trademark NAFION®. A preferred class of electron conductors are graphitic carbon, and a particular example is XC-72 a high purity furnace black produced by the Cabot Corp. The invention is most pertinent to ECLs in which the electrocatalyst is platinum or contains platinum, e.g., a platinum/ruthenium and/or oxides of ruthenium mixture. If a platinum ruthenium mixture is used as the electrocatalyst, the mole ratio of Pt to Ru ranges from about 2 to about 0.5, preferably between about 1.2 to about 0.8. However, it is to be understood that platinum may comprise up to 100% of the catalytic material for cathodes. Electrocatalytic particulates range in mean particulate diameter from about 1 to about 20 nanometers (nm). Loading of electrocatalytic material, based on total weight of ECL material, i.e., ionomer plus carbon plus electrocatalytic material plus refractory oxide, ranges between about 30 and about 80 weight percent. The refractory oxide is employed at between about 20 and about 200, preferably 50 to 150 weight percent relative to weight of the electrocatalytic material, or alternatively between about 5 and about 60 weight percent of the total ECL material, and more preferably 20 to 50 percent. A currently preferred refractory oxide is silica; however, refractory oxides may be selected from the group consisting of silica, ceria, yttria, zirconia, titania, rare earth oxides, and mixtures thereof. The electrically conductive material particulates are used at between about 0 and about 30 wt % relative to the total ECL content. Refractory oxide particulates range in size from about 2 nm to about 100 nm. Particulates of electrically conductive material, e.g., carbon particulates, range in size from about 100 nm to about 5000 nm. The DMFC of the present invention can be made of any size from microelectronic and implant application size to portable power, automotive and even power station size. Thus the desired power produced can be from milliwatts to kilowatts. For battery replacement the DMFC will usually provide power from 1 mW to 50 W. The ECH of the present invention is preferably used for methanol fueled fuel cells, but can be used and be beneficial with other fuels including partially or fully reformed fuels and even pure hydrogen. The fuel used is not meant to be limiting to the present invention.

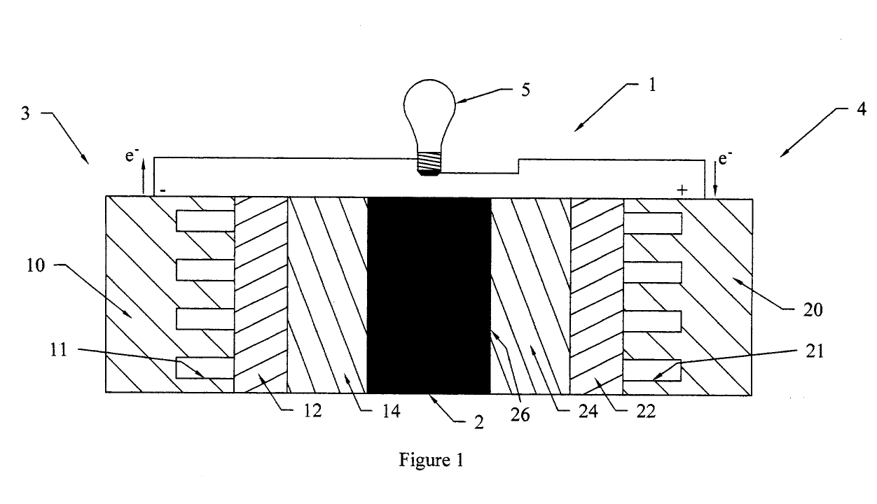

The illustrated direct methanol fuel cell 1 in FIG. 1 is provided with a solid polymer electrolyte membrane 2 in the middle, an oxidation or anode electrode 3 at one side thereof to which methanol, an oxidizable fuel, is supplied, and a reduction or cathode electrode 4 at the other side to which air as an oxygen source is supplied.

With respect to FIG. 1, on the left-hand (anode electrode 3) side is a fluid flow plate 10 having grooves 11 that separate fluid, i.e., liquid methanol, and collects gas generated, i.e., carbon dioxide. This may be formed of conductive material, such as stainless steel or graphite, and machined to form the fluid diffusion grooves. Adjacent to the fluid flow plate 10 is a conductive carbon gas diffusion layer (GDL) 12. Inward of this is a catalyst layer 14 into which the liquid methanol diffuses and is oxidized to form the protons that diffuse through the proton exchange membrane 2 toward the cathode 4 side.

The cathode electrode structure 4 is similar to the anode electrode 3 structure, having from right-to-left with respect to FIG. 1 a gas flow plate 20 having gas flow grooves 21, a GDL 22, and the layer 24 into which oxygen gas diffuses and receives protons from the proton-conducting membrane 2 to reduce the oxygen. In a DMFC, H⁺ ions (protons) are produced from methanol in the anode 3 and migrate from the anode side 3 to the cathode side 4 through the electrolyte membrane 2. Electrons generated in the anode electrode 3 perform external work in a load 5, and the electrons then return to the cathode electrode 4 of the fuel cell 1.

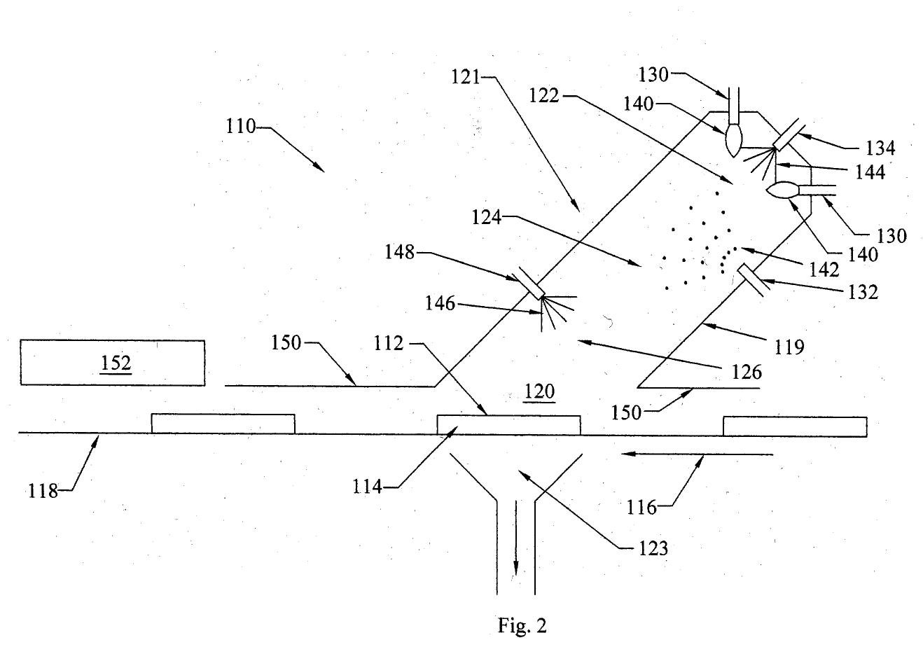

Illustrated in FIG. 2 is a diagrammatic representation of the deposition apparatus 110 by which electrocatalyst may be deposited on a surface 112 of a substrate 114 that is transported in the direction of arrow 116. (The apparatus could also be operated with the substrate transported in the direction opposite to that shown by arrow 116.) The substrates 114 illustrated in FIG. 2 are pre-cut individual substrate sheets carried by a horizontally moving conveyer 118 through a deposition zone 120. As an alternative, the substrate could be a continuous reel transported between an upstream roll and a downstream roll.

With reference to a method in which the components of the electrocatalyst, i.e., the catalytic particulates, the electrically conducting particulates, a polymer (ionomer, e.g., NAFION®) and refractory oxide particulates, are individually introduced into and/or formed within the apparatus, a deposition housing 119 provides an elongated passageway or tunnel 121 providing an upstream catalyst introduction region 122, an intermediate drying region 124, a downstream ionomer mixing region 126, and the deposition region 120 downstream of the mixing region 126. It is to be understood that the apparatus 110 provides a continuous flow of material that is processed in and flows through the tunnel 121, and that there is no sharp delineations between the above-described regions that are described herein in functional terms with respect to the deposition process.

In a currently preferred embodiment, nozzles 130 and 134 are used to introduce material into the upstream catalyst-introduction region 122 of the tunnel 121. Through nozzles 130 are introduced a precursor solution for catalyst, such as platinum, ruthenium, gold, palladium, etc. and mixtures of such catalyst precursors. The precursor solution is introduced as a finely divided aerosol is preferably produced by apparatus described in U.S. Pat. No. 6,132,656, (hereby incorporated by reference), that is capable of producing sub-micron droplets of solution. The apparatus described in U.S. Pat. No. 6,132,656, in which fluid is atomized by passage under pressure through a heated tube, is advantageously utilized in the processes of the invention whenever very fine droplets of fluid are desired. Where very fine droplets are not required, more conventional atomizing apparatus, such as apparatus that atomizes fluids by shear forces, may be used. Thus, then the term “nozzle” is used herein, it is to be understood that nozzle selection will be according to the requirements of the particular deposition method chosen. The various nozzles described herein extend through ports in the housing 119; and the various ports can facilitate alternate types of nozzles according to the requirements of the particular deposition method or can be selectively closed off if not required for the particular deposition method.

Using the apparatus described in U.S. Pat. No. 6,132,656 in conjunction with dilute solutions of catalyst precursor, very tiny particulates of catalyst may be produced, e.g., having mean particulate diameters in the range of from about 1 nanometer to about 2000 nanometers. The carrier liquid in the solution is a flammable liquid or mixture of flammable liquids and the atomized droplets are ignited to produce CCVD flames 140 as described in U.S. Pat. No. 5,652,021, (hereby incorporated by reference). Precursor chemicals for Pt, Ru, Au, Pd, and a variety of other metals are described, for example, in U.S. Pat. No. 6,208,234. The teachings of all patents and applications discussed herein are incorporated by reference.

The apparatus in above-discussed U.S. Pat. No. 6,132,656 atomizes a fluid by passing them through a tubular pressurized region and heating the fluid while in this tubular portion. When the fluid exits the tube, the pressure drops; the fluid rapidly atomizes into very small droplets, and evaporation of liquid components from the tiny droplets happens very rapidly. When such apparatus is used for one or more of the fluids, the vaporizing liquid(s) contribute significantly to the gas through-put of the apparatus, it being appreciated that gas has a volume about 3 orders of magnitude than liquid. By use of such apparatus in which liquid(s) is almost instantaneously turned to gas in the apparatus, helping to maintain separation of spray particles and aiding in drying. This contributes to deposition efficiency of the apparatus. A flux of layer-forming particulates is produced within the tunnel 121.

In one embodiment, through nozzle 134, at the upper end of the tunnel 121, is introduced a spray 144 of carbon particulates of mean particulate diameter of between about 20 and about 5000 nanometers dispersed in a solution of water and isopropyl alcohol. A small amount of NAFION can be added to the carbon particulates solution. The water in this dispersion not only acts to prevent combustion of the finely divided carbon particulates in the adjacent flames 140, but also acts to quench the flame-produced vapors and precipitate out very fine particulates of catalyst. This quench also “freezes” the catalyst particle size at a desired small size (small mean particulate diameter) as is described further in International Patent Application No. PCT/US00/35416.

In the intermediate region 124, heat from the flame vaporizes the carrier liquid, e.g., water and isopropyl alcohol, for the carbon particulates. At the same time, CCVD-produced catalytic particulates, e.g., platinum or platinum/ruthenium, mix with and deposit on surfaces of the carbon particulates, thereby producing, in situ, particulates of carbon-supported catalyst and if NAFION was added, then catalytic material also on NAFION and interfaces. The amount of fluid in spray 144 is tuned to the heat source, which is illustrated as the flame 140 such that the carbon-supported catalyst at the end of the intermediate region is substantially dry and free-flowing as it enters the downstream ionomer mixing region 126. Because the carbon-supported catalyst particulates are substantially dry and free-flowing, they do not agglomerate, but instead are mixed with a finely divided spray or aerosol 146 of ionomer (generally aqueous) solution/suspension introduced through nozzle 148 to the mixing region, and produce a layer-forming material in which individual carbon-supported catalyst particulates are individually contained and isolated within the ionomer. In a currently used deposition method, the refractory oxide particulates, e.g., silica, are suspended within the ionomer solution/suspension that is introduced as spray 146 from nozzle 148. Remaining thermal energy from the flames drives off a substantial amount of the carrier liquid from the ionomer, although some carrier liquid may be left in the material as it is deposited in the deposition region 120 on the substrate surface 112. The composite ECL-forming material must be sufficiently dry to adequately disperse and uniformly deposit on the substrate. It is preferred that the coating be uniform in regard to the permeability of the substrate. While nozzle 148 is illustrated as delivering only a spray 146 of oxide-containing ionomer solution/suspension, additional flames or other heat sources (not shown) may be provided in association with nozzle 148 to provide further thermal energy as may be needed to achieve the requisite drying. By introducing refractory oxide via a flame or other fluid stream locally to formation of the catalytic material, they become intermingled and more similarly concentrated in the end ECL.

The apparatus shown in FIG. 2 allows for other modes of operation. The carbon, instead of being introduced in wet form through nozzle 134, could be introduced as a dry cloud 142 through nozzle 132, in which case water, as a quench liquid, might be introduced as spray 144 through nozzle 134. Instead of silica being particulates suspended in the NAFION solution/suspension introduced through nozzle 148, silica (or other refractory oxide) particulates could be produced along with the catalytic particulates by CCVD flames 140. Alternatively, one of the two illustrated CCVD flames 140 could be used to form the catalyst particulates, and the other used to form the oxide particulates.

It is further to be appreciated that while the FIG. 2 apparatus is one apparatus useful for forming ECL layers in accordance with the invention, this apparatus is not necessary for practice of the invention. All of the materials, the catalytic particulates, e.g., platinum, the electrically conductive particulates, e.g., carbon, the refractory oxide, e.g., silica, and the ionomer, e.g., NAFION, could all be dissolved and/or suspended in a carrier liquid medium, applied as a wet layer on a substrate surface and dried. While CCVD is a preferred method it is not required nor meant to be limiting to the end formed material. Besides enabling catalytic activity the oxide material also can minimize methanol cross-over, and thus can be beneficial on either or both sides.

### EXAMPLE

Electrocatalytic layers were deposited containing platinum without (A) and with (B) silica.

TABLE I
Analytical and electrochemical data for (A) and (B).

| | | | | Specific electro- |
|---|---|---|---|---|
| | Pt loading | Nafion loading, | SiO₂ loading | chemical surface |
| Sample | (ug/cm²) | (ug/cm²⁾ | (ug/cm²) | area in m²/g |
| A | 223 | 17 | 0 | 14.1 |
| B | 213 | 3 | 92 | 10.8 |

TABLE II
Deposition conditions for (A) and (B).

| | Pt | Nafion conc. | Silica | Substrate | Depos. | Substrate | Solution C |
|---|---|---|---|---|---|---|---|
| | conc. | % mass; | conc. | motion | Time | temperature | concentration |
| Sample | (mM) | N134:N148. | % mass | (cm/min) | (min) | (° C.) | (% mass) |
| A | 100 | 0.125%:1.56% | 0 | 6.41 | 11.25 | 114-151 | 0.4 |
| B | 40 | 0%:0.2% | 0.21% | 2.95 | 24.12 | 153-182 | 0.3 |

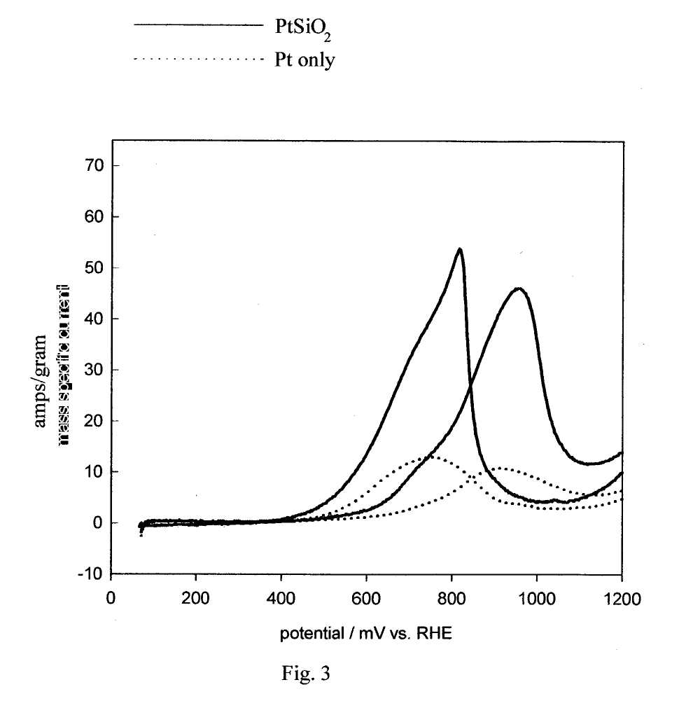

FIG. 3 is a graph plotting mass specific current in amperes per gram of Pt versus potential /millivolts vs. a regular hydrogen electrode. The cyclic voltametric data was obtained at a sweep of 20 mV/s at room temperature and in a 0.1M H2SO4+0.5 M MeOH electrolyte. A dramatic improvement in specific current can be seen when silica is added. Both the MeOH oxidation peak (˜900 mV) and the electrocatalytic oxidation peak (˜750 mV) are both seen the increase by a factor of greater than 5.

What is claimed is:

1. An electrocatalytic layer comprising a porous ionomeric matrix, particulate electrocatalytic material supported by said ionomeric matrix, carbon, and, in an amount sufficient to enhance the efficiency of said electrocatalytic material, a refractory oxide.

2. The electrocatalytic layer according to claim 1 wherein said electrocatalytic material comprises platinum and ruthenium.

3. The electrocatalytic layer according to Clam 1 wherein said refractory oxide is selected from the group consisting of silica, ceria, yttria, zirconia, titania, rare earth oxides, and mixtures thereof.

4. The electrocatalytic layer according to claim 1 wherein said refractory oxide comprises silica.

5. The electrocatalytic layer according to claim 1 further comprising particulates of conductive material.

6. A direct methanol fuel cell utilizing the electrocatalytic layer of claim 1 as the anodic electrocatalytic layer.

7. A porous ECL comprised of electrical conductor, ionomer, catalytic and refractory oxide materials.

8. The ECL according to claim 7 wherein said catalytic material is composed at least in part of platinum.

9. The ECL according to claim 7 wherein said electrical conductor is carbon.

10. The ECL according to claim 7 wherein said ionomer is a proton conducting polymer.

11. The ECL according to claim 7 wherein said refractory oxide silica, ceria, yttria, titania or rare earth oxide.

12. The ECL according to claim 7 wherein said refractory oxide is predominantly mixed with said ionomer.

13. The ECL according to claim 7 wherein said refractory oxide is predominantly mixed with said catalytic material.

14. The ECL according to claim 7 wherein said catalytic material is predominantly supported by said electrically conductive material.

15. The ECL according to claim 7 wherein said catalytic material is not supported by said electrically conductive materials.

16. The ECL according to claim 7 wherein said refractory oxide composes 5 to 60 weight percent of the ECL.

17. The ECL according to claim 7 wherein said refractory oxide composes 20 to 50 weight percent of the ECL.

18. The ECL according to claim 7 wherein said refractory oxide is 50 to 150 weight percentage relative to weight of the catalytic material.

19. A DMFC composed of at least one ECL that contains refractory oxide to enhance performance.

20. The DMFC of claim 19 wherein said refractory oxide composes at least 5 weight percent of said ECL.

21. The DMFC of claim 19 wherein the DMFC provides continuously available power in the range of 1 mW to 50 W.
